(19) United States
(12) Patent Application Publication
(10) Pub. No.: US 2024/0106126 A1
(43) Pub. Date: Mar. 28, 2024

(54) CONTACTLESS MULTI-DROP AND BROADCAST BIDIRECTIONAL COMMUNICATION SYSTEM

(71) Applicant: Intel Corporation, Santa Clara, CA (US)

(72) Inventors: Zhen ZHOU, Chandler, AZ (US); Tolga ACIKALIN, San Jose, CA (US); Kenneth FOUST, Beaverton, OR (US); Shuhei YAMADA, Vancouver, WA (US); Tae Young YANG, Portland, OR (US); Timothy F. COX, Palo Alto, CA (US); Renzhi LIU, Portland, OR (US); Richard DORRANCE, Hillsboro, OR (US); Johanny ESCOBAR PELAEZ, Zapopan (MX)

(21) Appl. No.: 18/352,296

(22) Filed: Jul. 14, 2023

(30) Foreign Application Priority Data
Sep. 27, 2022 (EP) 22 197 999.0

(51) Int. Cl. H01Q 9/04; H01Q 1/22

(52) U.S. Cl. CPC H01Q 9/0414; H01Q 1/2283; H01Q 9/045

(57) ABSTRACT

A communication system, including a first carrier and a first antenna mounted on the first carrier; a second carrier and a second antenna mounted on the second carrier, wherein the first antenna and the second antenna are arranged relative to each other that the first antenna and the second antenna can establish wireless link; a third carrier and a third antenna mounted on the third carrier; a fourth carrier and a fourth antenna mounted on the fourth carrier, wherein the third antenna and the fourth antenna are arranged relative to each other that the third antenna and the fourth antenna can establish wireless link; and a transmission structure, within which the signal propagate through, connects the second antenna and the third antenna.

### CROSS REFERENCE TO RELATED APPLICATIONS

This application claims priority to European patent application 22 197 999 filed on Sep. 27, 2022 the entire content of which is hereby incorporated by reference.

### TECHNICAL FIELD

The present disclosure relates to contactless multi-drop and broadcast bidirectional communication systems and antenna structures for wireless communications.

### BACKGROUND

Today's emerging technologies and applications continue to increasingly demand or require greater computational power. More input-outputs (I/Os) and functionalities have been added in each generation of server or client computing products to enhance the computing horsepower and user experiences along with more sideband signals for testing and control purpose. However, it becomes extremely difficult to implement the I/Os and functionalities in a single motherboard, and consequently the industry ended up with splitting a single motherboard into a few motherboards as a pragmatic approach.

The communication between the split motherboards currently relies on cable-based interconnects. However, the physically wired cable-based solutions typically require connectors to be placed at the edge of the motherboards, which takes a significant amount of motherboard area. In case that the signal originates in the center of the motherboard, the signal must be routed towards the edge of the motherboard which adds routing complexity.

Previously, wireline interconnects such as cable connections, and directive wireless communication has been used to overcome these challenges. However, wireline interconnects lack the flexibility of broadcasting and multi-drop besides the routing difficulties and mechanical problems. Further, conventional wireless communication can experience multipath problem and high channel loss, and hence the communication distance of wireless communications can be very limited.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A to 1C show schematic cross-sections of device-to-device communication systems;

FIG. 2A and FIG. 2B show schematic top views of a communication link structure of a device-to-device communication system;

FIGS. 3A to 3G show illustrations of various device-to-device communication systems;

FIGS. 4A to 4D illustrate an antenna structure for a device-to-device communication system;

FIGS. 5A to 5D illustrate another antenna structure for a device-to-device communication system; and

FIGS. 6A to 6C illustrate another antenna structure for a device-to-device communication system.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The device-to-device communication system provided employs near field antennas and a transmission line to realize contactless multi-drop communications between devices of split motherboards, e.g. a controller and devices. Thus, the device-to-device communication system enables signal escape about in the middle of a printed circuit board (PCB) wirelessly and to which the signal propagate through as a guided wave structure implented in a flex substrate which may be attached to a chassis for routing flexibility. Alternatively, or in addition, the number of PCB layers can be reduced and the routing space currently reserved for those sideband signals may be repurposed for the usage which can benefit some of the high-speed signals' integrity.

Thus, compared to current state-of-the-art wired solutions, the device-to-device communication system may provide multi-drop, and hence offers flexible floor planning for a split motherboard placements. Further, different from a previously used wireless communications, the device-to-device communication system may reduce reflection, path loss, and hence may increase the transmission distance. Thus, since a part of signal propagation happens as a guided wave, the group delay distortion introduced by the communication channel is lower than in a previously used wireless channel. Therefore the equalization and decoding can be simplified to save power, reduce latency, and reduce design complexity and engineering cost.

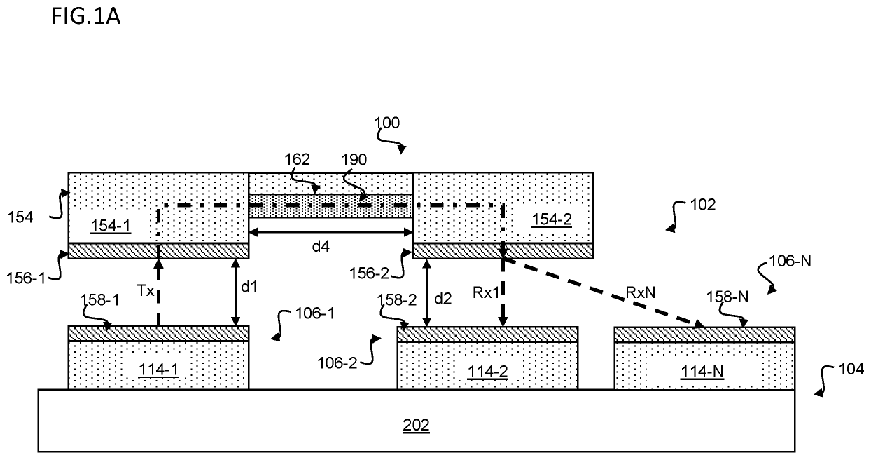

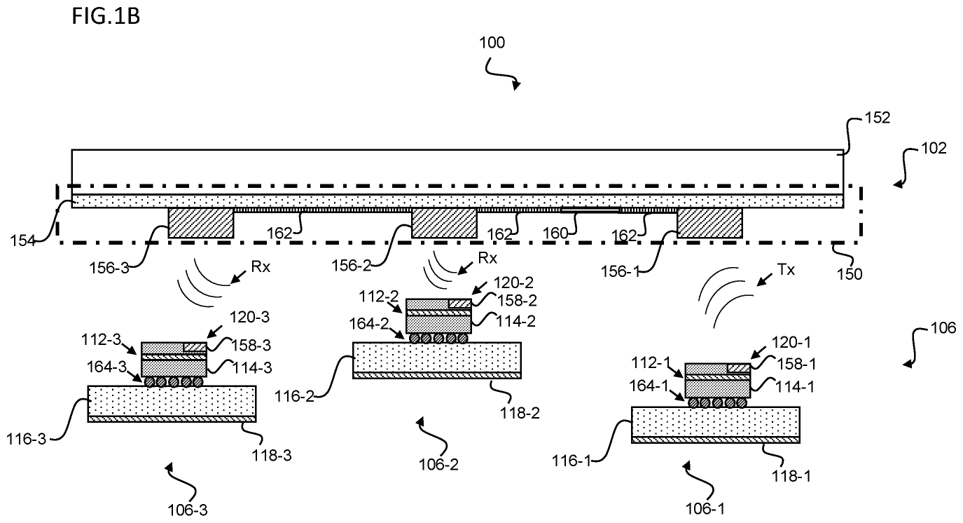

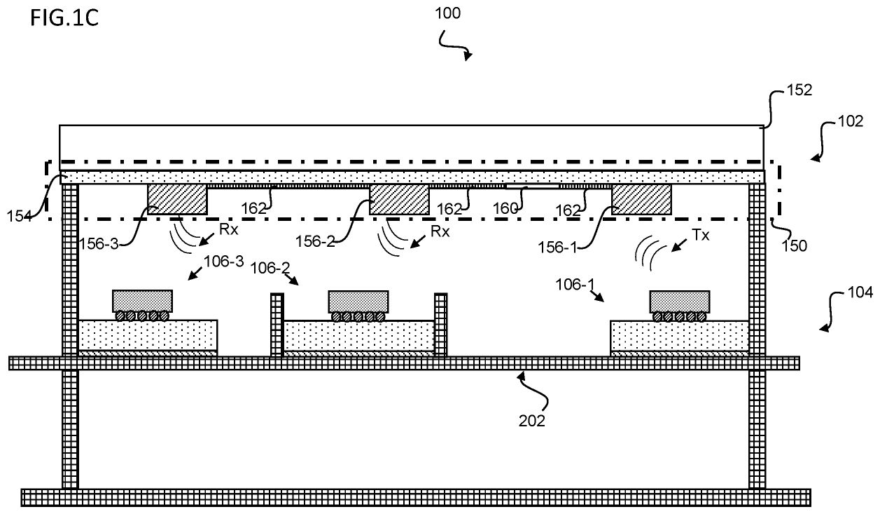

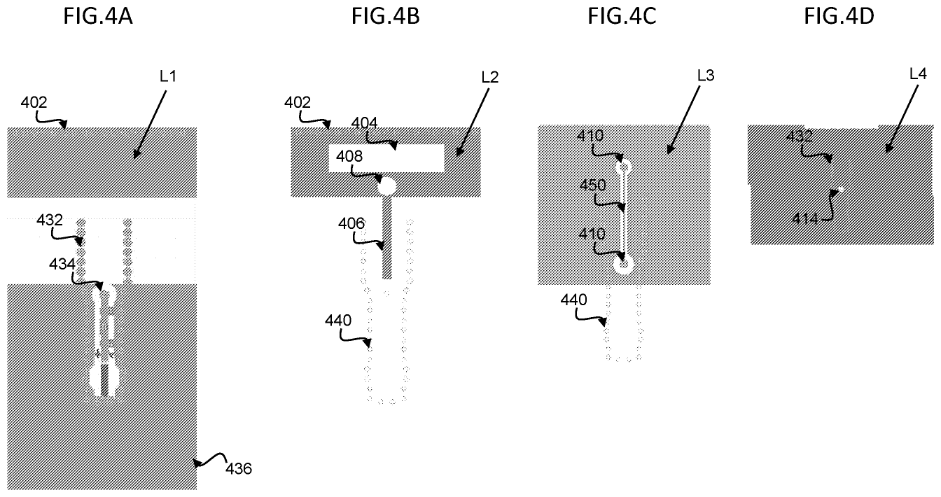

Details of the contactless multi-drop and broadcast bidirectional communication system are illustrated in FIG. 1A to FIG. 3G. A compact package integrated near field complementary dipole antenna that may be used in the contactless multi-drop and broadcast bidirectional communication system is illustrated in FIG. 4A to FIG. 6C.

FIG. 1A illustrates a schematic cross-section of a device-to device communication system 100. In the following, the device-to device communication system 100 will be explained using the illustrative example of a chiplet-to-chiplet communication system.

A chiplet may be a functional block in the form of an integrated circuit that can be specifically designed to work with other chiplets to form larger more complex chip packages. That is, chiplets may refer to the independent constituents which make up a chip package built out of multiple chiplets. Chiplet(s) may be provided with or without encapsulating material packaging the chiplet(s). As used herein, the term “chiplet” includes an integrated circuit block of a multi-chip module (MCM) or MCM devices.

A chiplet can be considered as typically a sub processing unit or circuitry or a disaggregated functional resource with a specialized function that is designed to integrate with other chiplets of a common multi-chip device or module or circuitry. A chiplet may be fabricated on its own individual semiconductor die with physical dimensions that are often smaller than other chips. The MCM provides interconnections of the chiplets so as to form complete electronic function(s). The MCM may be an electronic assembly where multiple chiplets and/or other discrete components are integrated so that in operation, the multiple chiplets can be treated as if they were a larger integrated circuit. The integration of disaggregated resources by way of integrating chiplets in a module may provide the computational power needed for today's applications.

An MCM can be an electronic assembly that may be a single package including multiple components or circuitries. An MCM can be a plurality of chiplets arranged in a single package including die-to-die interconnect schemes for connecting the chiplets. In such cases, the chiplets of an MCM can be integrated and mounted onto a unifying carrier, so that in use it can be treated as if it were a larger IC. The unifying carrier may be a package carrier or system carrier. The chiplets (and possibly other components) of the MCM may also share a common enclosure or encapsulation and a common integrated heat spreader (IHS).

An MCM may in some cases include components other than chiplets. That is, an MCM may include integrated devices that have their own packaging, such as, for example, Central Processing Units (CPUs), Graphical Processing Units (GPUs), Field Programmable Gate Arrays (FPGA), Digital Signal Processors (DSPs), Application-Specific Integrated Circuits (ASICs) etc. Such components with their own packaging can be arranged on a common carrier or base layer (e.g. the system carrier or motherboard) within in relatively close proximity to each other in the MCM.

However, the devices of the device-to-device communication system 100 are not limited to chiplets and MCM. As an example, a device may be any kind of a die, a chip, a module, or a rack. Thus, the device-to device communication system may be symmetrical, e.g. a chiplet-to-chiplet communication system or may be asymmetrical, e.g. a chip-to-rack communication system.

The device-to-device communication system 100 may include a plurality of packages 106 wirelessly coupled to a communication link structure 102 (illustrated as dashed line arrow Tx, Rx in FIG. 1A) that provides a wired communication link (illustrated as dash-dotted line arrow 190 in FIG. 1A). This way, the routing of the package communication interconnections between individual packages of the plurality of packages 106 can be simplified.

Illustratively, the device-to device communication system 100 may include a first carrier 114-1 and a first antenna 158-1 mounted on the first carrier 114-1, and a second carrier 154-1 and a second antenna 156-1 mounted on the second carrier 154-1. The first antenna 158-1 and the second antenna 156-1 may be arranged relative to each other so that the first antenna 158-1 and the second antenna 156-1 can communicate wirelessly with each other (in FIG. 1A illustrated by a dashed arrow Tx). The first carrier 114-1 and the second carrier 154-1 may be arranged at a predefined first distance d1 from each other. The first distance d1 may be smaller than or equal to about three times the wavelength of a wireless signal Tx transmitted between the first antenna 158-1 and the second antenna 156-1. The first antenna 158-1 and the second antenna 156-1 may be galvanically separated from each other.

The device-to device communication system 100 may further include a third carrier 154-2 and a third antenna 156-2 mounted on the third carrier 154-2, and a fourth carrier 114-2 and a fourth antenna 158-2 mounted on the fourth carrier 114-2. The third antenna 156-2 and the fourth antenna 158-2 may be arranged relative to each other so that the third antenna 156-2 and the fourth antenna 158-2 can communicate wirelessly with each other (in FIG. 1A illustrated by a dashed arrow Rx1). The third carrier 154-2 and the fourth carrier 114-2 may be arranged at a predefined second distance d2 from each other. The second distance d2 may be smaller than or equal to about three times the wavelength of a wireless signal transmitted between the third antenna 156-2 and the fourth antenna 158-2. The third antenna 156-2 and the fourth antenna 158-2 may be galvanically separated from each other.

The device-to device communication system 100 may further include a waveguide structure 162. The waveguide structure 162 may be a guided-wave structure. Alternatively, or in addition, the waveguide structure 162 may be transmission medium. Alternatively, or in addition, the waveguide structure 162 may be a transmission line. A first portion of the waveguide structure 162 may be mechanically coupled to the second antenna 156-1 and a second portion of the waveguide structure 162 (see FIG. 1B) may be physically coupled to the third antenna 156-2 to allow a transmission of electromagnetic signals between the second antenna 156-1 and the third antenna 156-2 via the waveguide structure 162 (in FIG. 1A illustrated by a dashed-dotted arrow 190). The waveguide structure 162 may be a structure selected from a transmission line; a waveguide; and a microstrip line or a combination thereof. Illustratively, the waveguide structure 162 may be a wired transmission line for communication signals, e.g. electrical signals and/or optical signals.

Illustratively, the first antenna 158-1 of a first package 106-1 wirelessly transmits Tx a signal to corresponding second antenna 156-1 of the communication link structure 102. The second antenna 156-1 receives the signal and propagates the signal 190 towards the third antenna 156-2 of the communication link structure 102 through a waveguide structure 162. The third antenna 156-2 wirelessly broadcasts Rx1, RxN the signal towards the second package 106-2 and any further package 106-N within range. As an example, the range maybe three times the wavelength of the signal to be transmitted. The respective antenna 158-2, 158-N of the package 106-2, 106-N receives the signal.

Thus, unlike the conventional contactless communication systems which only serve a point-to-point communication, the illustrated device-to-device communication system 100 uses two or more antennas 156-1, 156-2 in the communication link structure 102. The antennas 156-1, 156-2 of the communication link structure 102 may be fabricated on a very thin flexible substrate 154 and may be interconnected through the waveguide structure 162 as a transmission line to form a bell-bar shape of a communication link on the flexible substrate 154. The device-to-device communication system 100 extends the link distance d1, d2 while enabling bidirectional multi-drop and broadcast capability by maintaining the wireless channels as short as possible, e.g. to the length of the distance of the packages to the communication link structure, while utilizing the low loss transmission medium of the waveguide structure (of the length of d4) on the flexible substrate 154 to extend the channel length.

The packages 106-1, 106-2, 106-N may be formed on different package carriers 114-1, 114-2, 114-N, e.g. motherboards. At least one of the first carrier 114-1 or the fourth carrier 114-2 may be rigid carriers. Alternatively, or in addition, at least one of the first carrier 114-1 or the fourth carrier 114-2 may be printed circuit boards. At least one of logic circuitry may be mounted on the first carrier 114-1 or logic circuitry may be mounted on the fourth carrier 114-2.

At least one of the second carrier 154-1 or the third carrier 154-2 may be flexible carriers, e.g. the second carrier 154-1 and the third carrier 154-2. Alternatively, or in addition, at least one of the second carrier 154-1 or the third carrier 154-2 may be flexible printed circuit boards (e.g. FlexPCBs).

The device-to device communication system 100 may further include a system carrier 202. The first carrier 114-1 and the fourth carrier 114-2 may be mounted on the system carrier 202.

The device-to device communication system 100 may further include at least one further carrier 114-N and a further antenna 158-N mounted on the further carrier 114-N (in general an arbitrary number of further carriers and further antennas mounted on the further carrier, e.g. two, three, four, or even more). The third antenna 156-2 and the further antenna 158-N may be arranged relative to each other that the third antenna 156-2 and the further antenna 158-N can communicate wirelessly with each other (in FIG. 1A illustrated by a dashed arrow RxN). The third antenna 156-2 and the at least one further antenna 158-N may be galvanically separated from each other. The at least one further carrier 114-N may be positioned next to the fourth carrier 114-2 on the common system carrier 202. The at least one further carrier 114-N may be a rigid carrier. Alternatively, or in addition, the at least one further carrier 114-N may be a printed circuit board. At least one of logic circuitry may be mounted on the at least one further carrier 114-N. The further carrier 114-N and the further antenna 158-N may be encapsulated in a further package.

The first carrier 114-1 and the first antenna 158-1 may be encapsulated in a first package 106-1. The fourth carrier 114-2 and the fourth antenna 158-2 may be encapsulated in a second package 106-2. In other words, the system 100 may include a first package 106-1 and at least a second package 106-2. The first package 106-1 may include the first carrier 114-1 and the first antenna 158-1. The second package 106-2 may include the fourth carrier 114-2 and the fourth antenna 158-2. The first package 106-1 and the second package 106-2 may be mounted on a shared system carrier 202.

One or more further package(s) 106-N (with N being between 2 and M, with M being an integer) may include respectively a further carrier 114-N and a further antenna 158-N. The third antenna 156-2 and the further antenna 158-N may be configured to establish a further wireless communication connection RxN.

FIG. 1B illustrates another schematic cross-section of device-to-device communication system 100 as described above.

FIG. 1B shows three packages 106-1, 106-2, 106-3 of a device-to-device communication system 100, i.e. a first package 106-1, a second package 106-2, and a third package 106-3. Each of the packages 106-1, 106-2, 106-3 may have a chiplet 120-1, 120-2, 120-3 coupled to the respective chiplet carriers 114-1, 114-2, 114-3. Each of the chiplets 120-1, 120-2, 120-3 may have a respective antenna 158-1, 158-2, 158-3.

The chiplet carriers 114-1, 114-2, 114-3 may be coupled to package carriers 116-1, 116-2, 116-3 via non-releasable interconnections 164-1, 164-2, 164-3, e.g. one of a ball grid array, a pin grid array, a land grid array or similar.

Each of the chiplets 120-1, 120-2, 120-3 may have a ground plane 112-1, 112-2, 112-3.

Each of the package carriers 116-1, 116-2, 116-3 (in FIG. 1A denoted as carriers) may have a ground plane 118-1, 118-2, 118-3.

The package carriers 116-1, 116-2, 116-3 may be arranged independently from each other in space, e.g. in the same level or different levels (illustrated in FIG. 1B).

FIG. 1B further illustrates that the communication link structure 102 may include an antenna carrier 154 that may be shared for the antennas 156-1, 156-2, 156-3 and/or the waveguide structure 162 of the communication link structure 102. In other words, the second carrier 154-1 and the third carrier 154-2 as described in FIG. 1A may be separated carriers or may be sections of a shared antenna carrier 154 (also denoted as communication link carrier 154). The communication link carrier 154 may be a flexible printed circuit board for example, a foil with or without back side ground plane as described in more detail below.

The communication link carrier 154 may be attached to a chassis 152 or a thermal solution, e.g. a heat spreader, located above the packages 106-1, 106-2, 106-3. The chassis 152 may be part of the packaging, housing or thermal solution of the module having the plurality of chiplets 106. As an example, the housing or packaging of the module may further include the system carrier 202 as illustrated in FIG. 1C

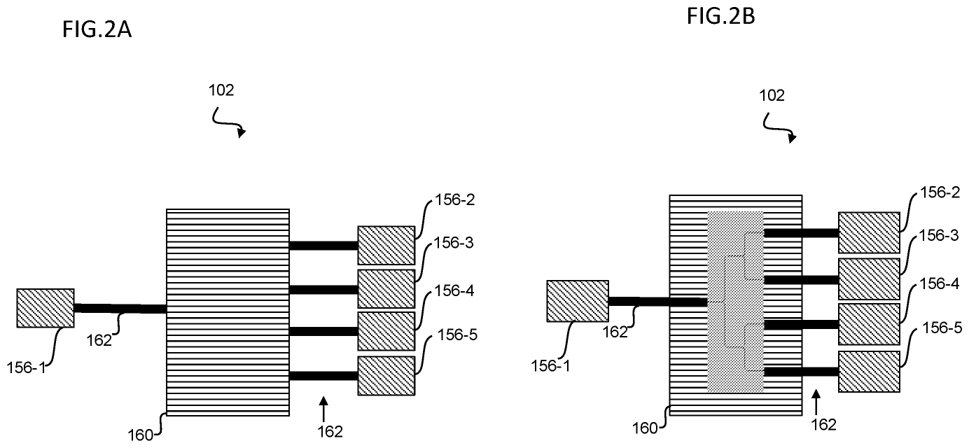

As further illustrated in FIG. 1B, the device-to-device communication system 100 includes wireless communications section Tx, Rx between individual packages 106-1, 106-2, 106-3 and the communication link structure 102, and wired communication sections within the communication link structure 102 using one or more waveguide structures 162 and multiplexing structures 160. The multiplexing structure 160 is described in more detail below, e.g. see FIG. 2A and FIG. 2B.

The device-to-device communication system 100 provides communication links between the packages 106-1, 106-2, 106-3 that may otherwise not be possible, e.g. due to the arrangement of the packages 106-1, 106-2, 106-3 relative to each other as illustrated in FIG. 1C. Note that reference numerals of components of the packages 106-1, 106-2, 106-3 have been omitted in FIG. 1C to avoid an unnecessary obstruction only.

FIG. 2A and FIG. 2B illustrate schematic top views of the communication link structure 102, e.g. the routing of the plurality of antennas 156-j (with j being an integer). Here, an antenna 156-1 may be coupled to two or more antennas 156-2, 156-3, 156-4, 156-5 by a multiplexing structure 160 via waveguide structures 162. Illustratively, the multiplexing structure 160 illustrated in FIG. 2A may be a signal splitter, e.g. a 1-to-4 splitter as illustrated in FIG. 2B. However, the multiplexing structure 160 may be any kind of a conventional signal routing structure, e.g. a switch, a bridge, a hub. This way, a signal received at the first antenna 156-1 may be routed to one or more or each of the antennas 156-2, 156-3, 156-4, 156-5.

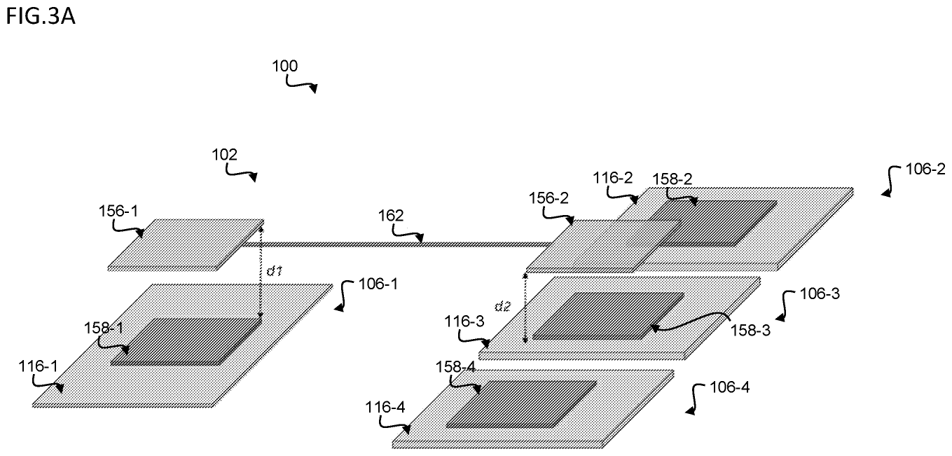

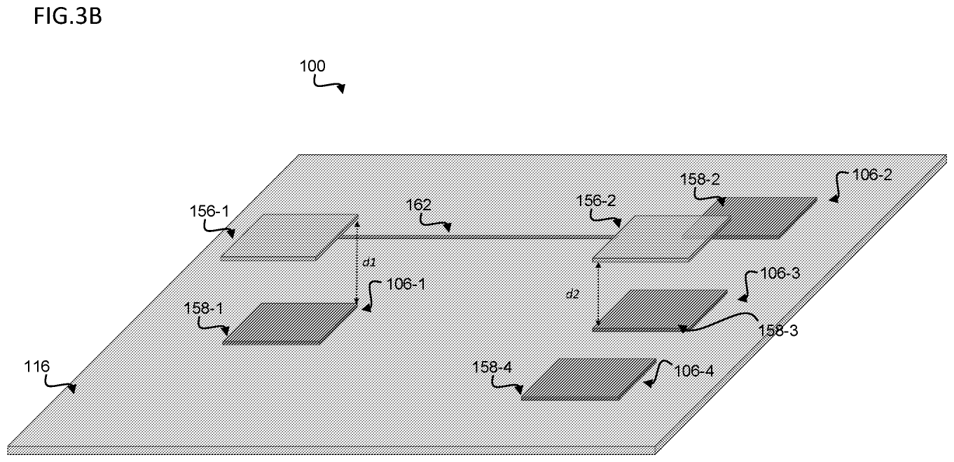

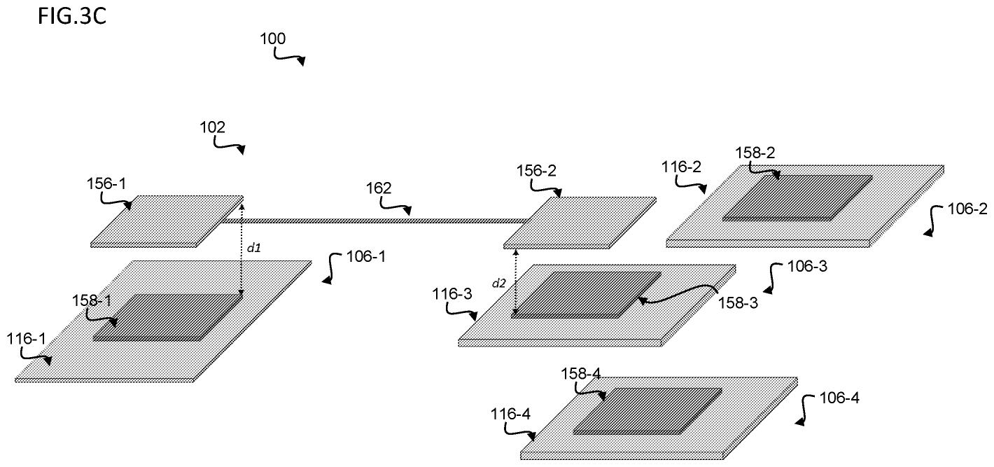

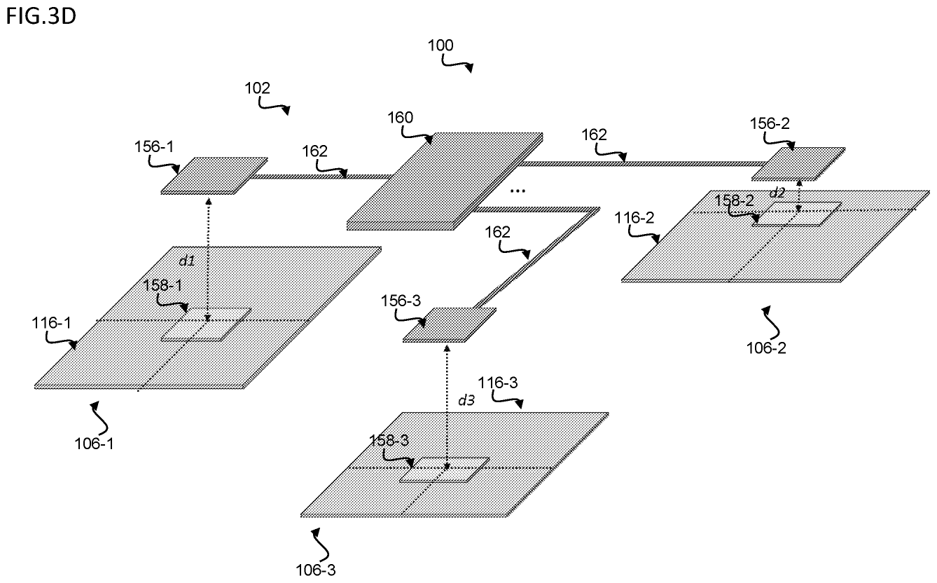

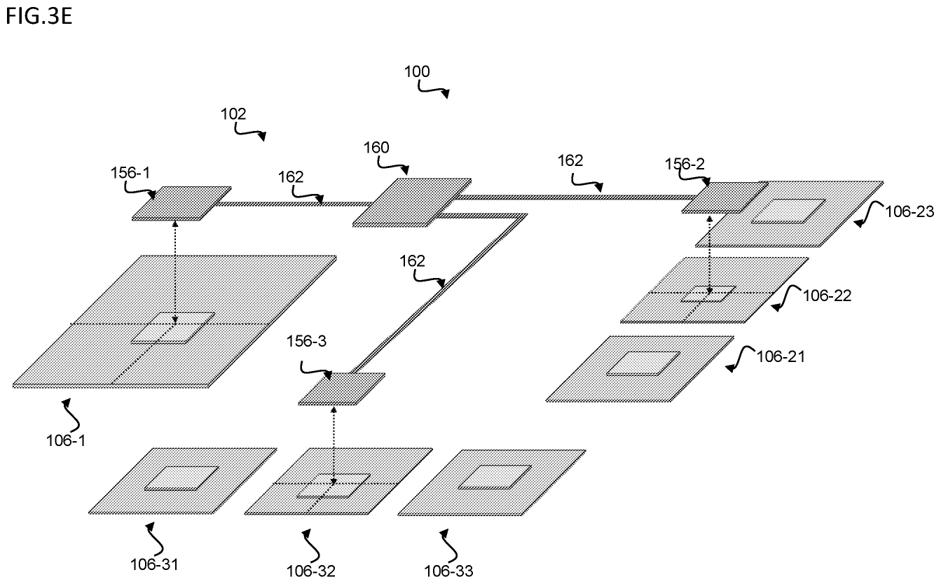

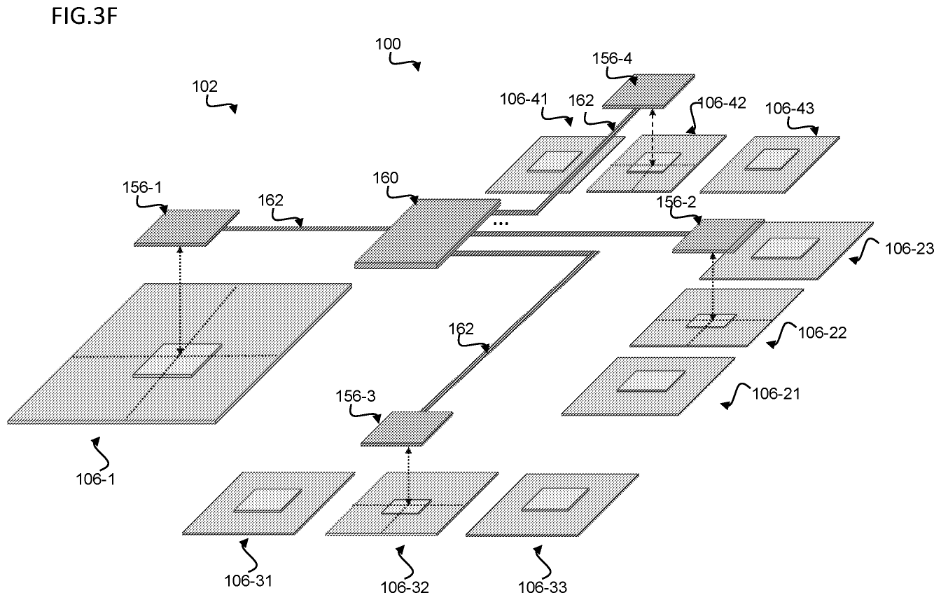

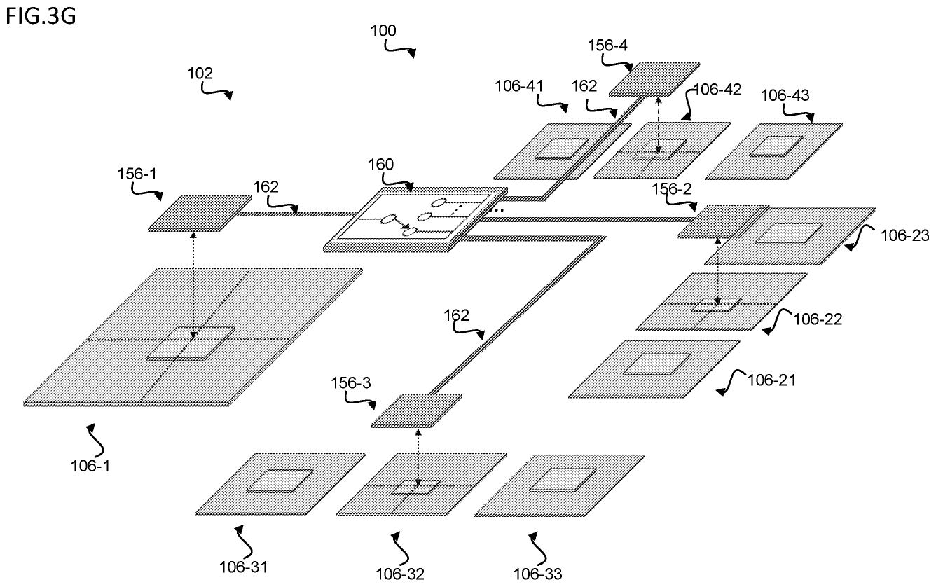

FIG. 3A to FIG. 3G show illustrations of various device-to-device communication systems. Note that the designation of components, e.g. first antenna, second antenna, etc., may differ from the designation of components in the respective figures depending on the respective illustrated feature of the communication system. The designation is only used to distinguish one component from another component. However, reference numerals designate the same components throughout the description.

FIG. 3A illustrates a device-to-device communication system 100 as described above wherein a first package 106-1 is communicatively coupled to one or more further packages 106-2, 106-3, 106-4 via the communication link structure 102. The communication link structure 102 may include a first antenna 156-1 wirelessly coupled to the antenna 158-1 of the first package 106-1 and a second antenna 156-2 wirelessly coupled to the antenna(s) 158-2, 158-3, 158-4 of one or more further packages 106-2, 106-3, 106-4. The first antenna 156-1 of the communication link structure 102 may be wirebound to the second antenna 156-2 of the communication link structure 102 via the waveguide structure 162. Note that one or more packages 106-2, 106-3, 106-4 may be wirelessly coupled to a single antenna 156-2, as illustrated in FIG. 3A. Thus, the second antenna 156-2 may provide a broadcast or multi-drop to the further packages 106-2, 106-3, 106-4.

Packages 106-2, 106-3, 106-4 adjacent to each other, e.g. in a sufficient proximity, may directly wirelessly communicate with each other, e.g. in case the lateral distance between adjacent packages 106-2, 106-3, 106-4 is less than about three times the wavelength of the signal. A direct wireless communication may use a near field communication link of the respective packages 106-2, 106-3, 106-4 also used to communicate with the antenna 158-2 of the communication link structure 102. Alternatively, or in addition, the antenna 158-2 may be shared by packages 106-2, 106-3, 106-4 to relay the wireless communication between adjacent packages 106-2, 106-3, 106-4, e.g. in case the distance between adjacent packages is larger than three times the wavelength of the signal, or a system carrier 202 or the alignment of packages 106-2, 106-3, 106-4 obstructs a direct communication between adjacent packages 106-2, 106-3, 106-4 (see also FIG. 1C). As an illustrative example, the distance between a second package 106-2 and a third package 106-3 may support a direct wireless communication link using their near field communication used to communicate with second antenna 158-2. However, the distance between the second package 106-2 and a fourth package 106-4 or their relative alignment may not allow a direct wireless communication using their near field communication. Thus the communication link between the second package 106-2 and the fourth package 106-4 may include the second antenna 158-2 as a relay station to relay the communication between the second package 106-2 and the fourth package 106-4.

Further illustrated in FIG. 3A, two or more or each of the packages 106-1, 106-2, 106-3, 106-4 may be formed on individual package carriers 116-1, 116-2, 116-3, 116-4, e.g. separated motherboards 116-1, 116-2, 116-3, 116-4. Alternatively, as illustrated in FIG. 3B, two or more packages 106-1, 106-2, 106-3, 106-4 of the plurality of packages may be formed on a common package carrier 116 or system carrier, e.g. share the same motherboard as package carrier 114. Further, alignment, orientation, level, and positioning of packages 106-1, 106-2, 106-3, 106-4 may be adapted depending on the application as illustrated in FIG. 3C and FIG. 3D. In other words, the packages 106-2, 106-3, 106-4 where the receiving antennas reside are not necessarily aligned and may be scattered around the second antenna 156-2 of the communication link structure 102 as long as they can receive the signal transmitted by the second antenna 156-2 of the communication link structure 102.

As an example, as illustrated in FIG. 3D, a first package 106-1 may be arranged in a first distance d1 from the communication link structure 102, a second package 106-2 may be arranged in a second distance d2 from the communication link structure 102, and a third package 106-3 may be arranged in a third distance d3 from the communication link structure 102. FIG. 3D shows three packages for illustration purpose only, and the device-to-device communication system may include further packages (illustrated by “ . . . ” in FIG. 3D).

Each of the distances d1, d2, d3 may be selected independently from the others. The distance d1, d2, d3 between the packages and the communication link structure 102 may be in a range from about 0.5 mm to about 5 mm, respectively.

In other word, the packages 106-1, 106-2, 106-3 may be arranged in different levels to each other.

The various above described features may be combined in a device-to-device communication system 100, as illustrated in FIG. 3E to FIG. 3G. Note that reference numerals of sub-components have been omitted for the sake of a better illustration only. The multiplexing structure 160 illustrated in FIG. 3E may be a 1:2 splitter, and the multiplexing structure 160 illustrated in FIG. 3F may be a 1:X splitter (with X being an integer) illustrated by “ . . . ” in FIG. 3F. However, the multiplexing structure 160 may also be configured as a switch or a bridge as illustrated in FIG. 3G, or any combination thereof.

Each of the antennas 156-1, 156-2, 156-3, 156-4 may be coupled to one or more packages 106-1, 106-21, 106-22, 106-23, 106-31, 106-32, 106-34, 106-41, 106-42, 106-43. However, the shown arrangement and number of packages per antenna 156-1, 156-2, 156-3, 156-4 of the communication link structure is chosen for illustration purpose only to illustrate the principle of the device-to-device communications system 100.

Further, the device-to-device communication system 100 may include two or more multiplexing structures 160 coupled to or interconnected with each other. Each of the multiplexing structures 160 may have one or more antennas 158-j, and one or more corresponding packages 106-N wirelessly coupled thereto. This way, a complex routing network may be be provided in an easy manner. Further, a module having the plurality of packages may have a plurality of device-to-device communication systems 100 that are communicatively coupled with each other or are communication systems 100 that are independent from each other. As an example, a package may be communicatively coupled to two or more device-to-device communication systems 100 at the same time. The two or more device-to-device communication systems 100 may be communicatively independent from each other. As an example, the two or more device-to-device communication systems 100 may be galavanicly isolated, e.g. direct current (DC)-wise, or disconnected, e.g. alternating current (AC)-wise, from each other. As an example, the antenna of the package may be a dual band or wide band antenna, and an antenna of a first communication system may support a first frequency band of the antenna of the package, and an antenna of a second communication system may support a second frequency band of the antenna of the package, wherein the first frequency band and the second frequency band are not overlapping. In other words, two or more device-to-device communication systems 100 may be configured to use non-overlapping wireless communication frequencies.

The communication distance between the transmitting package and receiving package(s) may be extended in an easy manner using the waveguide structure 162 and the multiplexing structure 160 of the communication link structure. This way, the device-to-device communication system 100 provides a more flexible layout design for modules having a plurality of devices, e.g. packages, chiplets, etc. Thus, modules requiring a complex routing layout may be provided in an easy manner.

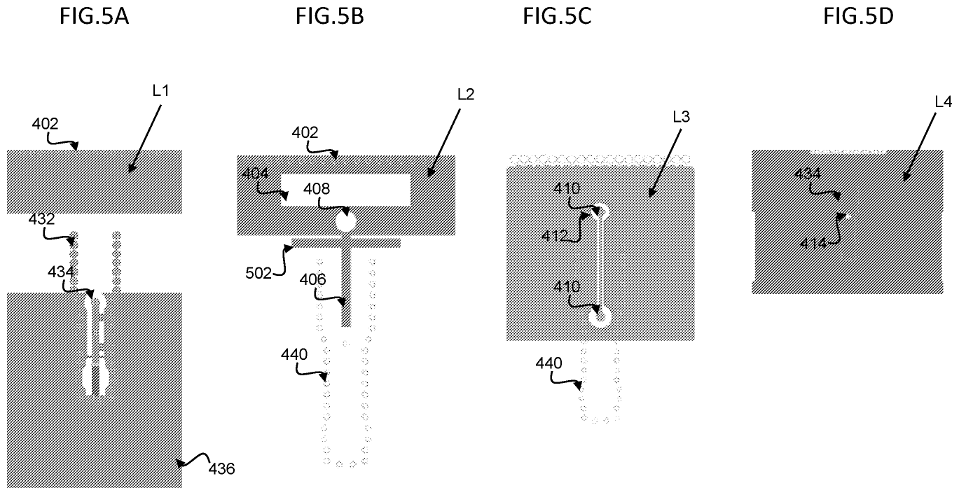

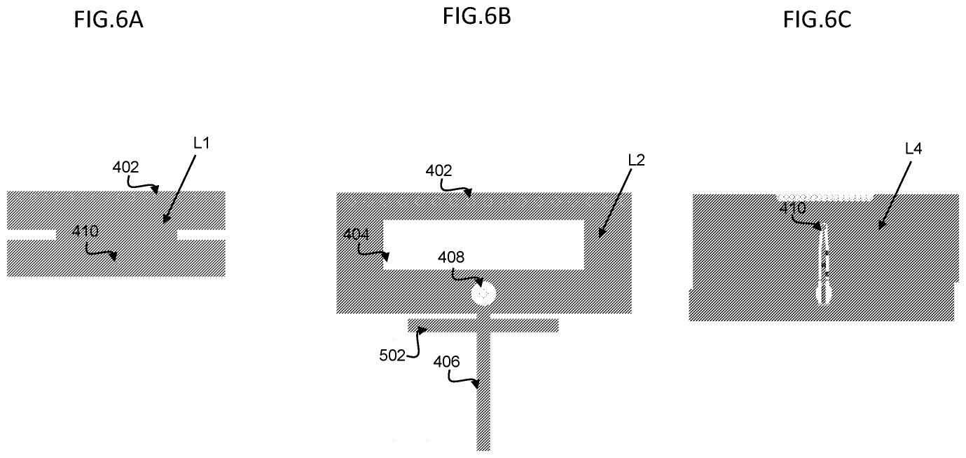

FIG. 4A to FIG. 4D, FIG. 5A to FIG. 5D, and FIG. 6A to FIG. 6C illustrate antenna structures for a device-to-device communication system. Illustrated are a first antenna structure (FIG. 4A to FIG. 4D), a second antenna structure (FIG. 5A to FIG. 5D), and a third antenna structure (FIG. 6A to FIG. 6C). Details of antenna layouts that may be used in the device-to-device communication system are shown in layer-by-layer illustration in FIG. 4A to FIG. 4D, FIG. 5A to FIG. 5D, and FIG. 6A to FIG. 6C, respectively. A backside ground plane may be arranged in L4. Each design illustrated in FIG. 4A to FIG. 4D, FIG. 5A to FIG. 5D, and FIG. 6A to FIG. 6C has a backside ground plane in L4. The design shown in FIG. 6A to FIG. 6C is free of metallization on L3.

The third layer patch L3 of the antenna arranged on the ground layer patch is illustrated in FIG. 4C, and FIG. 5C. In other words, every design illustrated in FIG. 4A to FIG. 4D, FIG. 5A to FIG. 5D, and FIG. 6A to FIG. 6C has a backside ground plane in L4 but not every design uses a third patch layer L3. For instance, the design illustrated in FIG. 6 A to FIG. 6C shows a design without third patch layer L3. When there is a backside ground plane, e.g. in L4, the third patch layer L3 may serve as a resonant frequency tuning element. When there is no backside ground plane in L4, the third patch layer L3 may acts as a retarded ground plane for the folded patch formed by a first patch layer L1 and a second layer patch L2 and vias between the patches in the first patch layer L1 and the second patch layer L2.

Thus, the antenna design illustrated in FIG. 6A to 6C may be used for antenna substrates without back side ground plane.

The second layer patch L2 may be formed above the ground layer patch L4 (shown in FIG. 4B, FIG. 5B, and FIG. 6B), e.g. over the third layer patch L3 (shown in FIG. 4B, and FIG. 5B).

The first layer patch L1 may be formed over the second layer patch L2 (shown in FIG. 4A, FIG. 5A, and FIG. 6A).

Note that the first layer patch L1 and the second layer patch L2 are stiched together by a via array 402 at one side of the patches forming the folded patch antenna.

Further note, that the first layer patch L1 and the second layer patch L2 may have about the same size, e.g. are congruent to each other. Thus, edges of the first layer patch L1 and the second layer patch L2 may be coupled to each other. However, the first layer patch L1 and the second layer patch L2 may have different sizes.

Further note, that the feed probe 410 is coupled to the first layer patch L1. Thus, the illustrated microstrip line 406 may not be used as feed but as a radiation component. Hence, the second layer patch L4 may be free of slits adjacent to the microstrip line 406 that are conventionally used for impedance matching.

Further note that the ground layer patch L3 has about the same size as the first layer patch L1 and the second layer patch L2. Here, the ground layer patch L3 may be be used for tuning the frequency of the antenna.

The antenna structures illustrated in FIG. 4A to FIG. 6C may be used for the antennas of the wireless communication connection between the package and the communication link structure, e.g. as an antennas in a package and/or as an antenna in the communication link structure, as described above.

The antennas of the communication link structure may be configured as variants of a folded patch antenna. This way, the antenna design simplifies the manufacturing of the communication link structure.

The folded patch antennas may be configured to have a wide half power beam width both in E plane and H plane. This way, the antenna may facilitate a broadcast ability of the device-to-device communication system.

The antennas of the package and the communication link structure may be configured to have a resonant frequency at about 9 GHz for example. The resonant frequency of the antenna of the communication link structure may be slightly higher than 9 GHz since the presence of the antenna of the package may capacitively load the antenna of the communication link structure. The capacitive loading may cause the resonant frequency of the antenna of the communication link structure to move to a lower frequency.

Illustratively, the antennas may be folded patch antennas on a multilayer printed circuit board. The antenna radiate towards the corresponding antenna of the wireless communication link Tx, RxN on its top with wide half power beamwidths on both the E plane and the H plane to support multidrop communication. The antenna may include a patch on a first layer (also denoted as L1 patch or first level patch L1), a patch on a second layer (also denoted as L2 patch or second layer patch L2), (optionally/design specific) a patch on a third layer (also denoted as L3 patch or third layer patch L3), and a patch on a layer or solid ground plane—also denoted as L4 patch, ground layer patch L4, or solid ground plane L4.

Each of the patch antennas is configured to provide a wide half power beam width in both E plane and H plane, and may serve as a broadcast antenna. The width of the L1 patch, the L2 patch, the L3 patch and the L4 patch may be λ/2 while its length may be λ/4 with λ being the wavelength corresponding to the resonant frequency of the antenna, e.g. about 9 GHz.

The presence of a backside ground on the antenna substrate may alter the impedance and radiation behavior of a folded patch antenna. The L4 patch may have the same dimension as the L1 patch, the L2 patch and the (optional) L3 patch.

The exemplary antenna layout illustrated layer-by-layer in FIG. 6A to FIG. 6C operates in a condition which does not involve a back side ground plane of the antenna substrate. In this design, the antenna may be constituted of two equal size patches—e.g. the L1 patch (FIG. 6A) and the L2 patch (FIG. 6B). The L1 patch and the L2 patch may be stitched together through the array of vias 402.

The L2 patch may include a rectangular shaped slot 404. The slot 404 may extend the current path along the folded patch. This way, a compact antenna may be provided.

The L2 patch may include a microstrip line 406. The microstrip line 406 encourages a vertical radiation emission.

The L2 patch may (optionally) include a stub structure 502 (see FIG. 5B and FIG. 6B). The stubs 502 may further reduce the size of the overall folded patch. However, the antenna design of FIG. 4A to FIG. 4D may also use the stub structure 502.

The folded patch antenna may be fed through a probe feeding 410 going from the L3 patch to the L1 patch through a circular aperture 408 in the L2 patch.

A variant of the folded patch antenna is shown in FIG. 5A to FIG. 5D. This variant may address alterations of the antenna behavior imposed by the existence of a back side ground plane of the antenna substrate. Compared to the antenna structure without the backside ground plane (FIG. 6A to FIG. 6C), the antenna may have a different probe feeding. Here, instead of probe feeding the L1 patch, the antenna is fed through a transmission line on the L3 patch underneath the strip on the L2 patch. The feeding signal couples to the folded patch through a circular aperture in the L3 patch and the L2 patch. Thus, the folded patch antenna may be formed by the rectangular L1 patch and L2 patch that are connected to each other through the array of vias 402. The folded patch may be floating on top of the L3 patch. The folded patch antenna may intentionally introduce a rectangular cut slot 404 in the L2 patch to extend the current path along the folded patch, and this way reduces the antenna size.

In contradiction to a traditional folded patch antenna with a ground plane much larger than the patch, the L3 patch may have a same size as the L1 patch and the L2 patch or may have a size that is slightly larger than the L1 patch and L2 patch, e.g. less than about 10% larger. The size of the L3 patch and its distance away from the folded patch antenna formed by the coupled L1-L2 patches may have significant impact on the folded patch antenna resonant frequency. Thus, the L3 patch may serve as a resonant frequency tuning element to tune the folded patch antenna resonant frequency, and hence may have a completely different purpose from a conventional folded patch antenna ground plane.

The patches on L1 and L2 which are connected by the vias 402 may form a magnetic dipole and may serve as a first radiation source. Besides, the top surface of L1 patch and the strip on L2 406 may have currents almost point to the same direction. This way, the top surface of the L1 patch and the strip on L2 406 may act as a second radiation source. The second radiation source may broaden the half power beam width in both the E plane and H plane. This, way the folded patch antenna may show an enhanced broadcast capability. Thus, radiation may occur in a completely different manner in the folded patch antenna compared to a conventional folded patch antenna in which the radiation occurs due to a slot formed by the top and bottom patches that both are shorted to the ground plane.

In other words, the antenna illustrated in FIG. 6A to FIG. 6C may include a ground layer L4; a second layer patch L2 over the ground layer L4; a first layer patch L1 over the second layer patch L2; a via array 402 may be arranged at at least one edge of the first layer patch L1 and second layer patch L2 and connecting the first layer patch L1 with the second layer patch L2. At least one feed probe 410 may be configured to feed the first layer patch L1.

The ground layer L4, the second layer patch L2 and the first layer patch L1 may be formed on the same side of the carrier 154 (see FIG. 1A to FIG. 1C). The carrier 154 may be free of back side ground layer.

A transmission line 406 may be arranged in the layer of the second layer patch L2 and connected to the second layer patch L2. Here, the transmission line 406 may be galvanically isolated (e.g. DC-wise) or disconnected (e.g. AC-wise) from the feed probe 410.

Alternatively, or in addition, the antenna illustrated in FIG. 4A to FIG. 5D may include a carrier 154, a ground layer L4; a third layer patch L3 over the ground layer L4, wherein the third layer patch L3 may include a waveguide structure 450 may be arranged in the layer of the third layer patch L3 and coupled to the third layer patch L3 and a first aperture 412; a second layer patch L2 over the third layer patch L3, and a microstrip line 406 may be arranged in the layer of the second layer patch L2 and connected to the second layer patch L2, and wherein the second layer patch L2 may include a second aperture 408; a first layer patch L1 over the second layer patch L2; a via array 402 may be arranged at at least one edge of the first layer patch L1 and second layer patch L2 and connecting the first layer patch L1 with the second layer patch L2. The ground layer L4, the second layer patch L2 and the first layer patch L1 may be formed on a first side of the carrier 154. The carrier 154 may include a back side ground layer on a second side opposite to the first side. A feed probe 410 may couple the first layer patch L1 with the waveguide structure 450 in the layer of the third layer patch L3 through the first aperture 412, the second aperture 408 and the waveguide structure 450.

Referring to the antennas in FIG. 4A to FIG. 6C, the second layer patch L2 may include a slot 404. The slot 404 may include a rectangular shape or any other kind of shape suitable to tune the frequency of the antenna. The slot 404 may be enclosed by the second layer patch L2. The feed probe 410 may be arranged adjacent to the slot 404.

The first layer patch L1 and/or the second layer patch L2 may include a rectangular shape. The first layer patch L1 and the second layer patch L2 may have about an equal size. The first layer patch L1 and the second layer patch L2 may have about an equal shape. The first layer patch L1 and the second layer patch L2 may be arranged superimposed. The first layer patch L1 and the second layer patch L2 may be arranged congruent.

The transmission line 406 may be connected to an edge of the second layer patch L2 opposite of the edge having the via array 402. The vias of the via array 402 may be electrically coupled in parallel.

The second layer patch L2 may be free of slits adjacent to the microstrip line.

One or more stubs 502 may be connected to the microstrip line 406. The stubs 502 may be configured as cross stub structure 502. The stubs may be configured as a plurality of cross stub structure 502 coupled along the transmission line 406.

A dielectric may be formed between the ground layer L4 and the second layer patch L2, and a dielectric may be formed between the second layer patch L2 and the first layer patch L1.

At least one of the first layer patch L1 and the second layer patch L2 may include a width that may be about λ/2, wherein the λ may be the wavelength corresponding to the designated resonant frequency of the antenna.

At least one of the first layer patch L1 and the second layer patch L2 may include a length that may be about λ/4, wherein the λ may be the wavelength corresponding to the designated resonant frequency of the antenna.

The first layer patch L1 and the second layer patch L2 may have about the same length and about the same width.

The antenna may be a folded patch antenna.

The ground layer patch L4 may include a rectangular shape. The ground layer patch L4 may have about an equal size to at least one of the first layer patch L1 and the second layer patch L2. The ground layer patch L4 may may have about an equal shape to at least one of the first layer patch L1 and the second layer patch L2. The ground layer patch L4, the first layer patch L1, and the second layer patch L2 may be arranged superimposed. The ground layer patch L4, the first layer patch L1, and the second layer patch L2 may be arranged congruent.

The layer of the first layer patch L1 further may include a feed network 432, a connector 434, and a matching network 436. Note that the vias 440 of the feed network 432 are illustrated in the L2 patch and in the L3 patch in FIG. 4B/C, and FIG. 5B/C.

The communication link structure (102, see above) for a chip module may include on an antenna substrate, e.g. a flexible substrate, a transmission structure, a first antenna having a first feed, and a second antenna having a second feed, wherein the transmission structure electrically conductively couples the first feed with the second feed. The communication link structure may include a thickness of less than 125 μm. In other words, the thickness of the substrate 154 of the communication link structure (see also FIG. 1A to 1C) may be less than about 100 μm (micrometre) for example.

The substrate may be a printed circuit board. At least one of the first antenna and the second may be configured according to one of the above describes examples.

In the following, various aspects of the present disclosure will be illustrated:

Example 1 is a communication system including a first carrier and a first antenna mounted on the first carrier; a second carrier and a second antenna mounted on the second carrier, wherein the first antenna and the second antenna are arranged relative to each other that the first antenna and the second antenna can establish wireless link; a third carrier and a third antenna mounted on the third carrier; a fourth carrier and a fourth antenna mounted on the fourth carrier, wherein the third antenna and the fourth antenna are arranged relative to each other that the third antenna and the fourth antenna can establish wireless link; and a transmission structure, within which the signal propagate through, connects the second antenna and the third antenna. The communication system may be a device-to-device communication system. In other words, the communication system may include a first carrier and a first antenna mounted on the first carrier; a second carrier and a second antenna mounted on the second carrier, wherein the first antenna and the second antenna are arranged relative to each other that the first antenna and the second antenna can communicate wirelessly with each other; a third carrier and a third antenna mounted on the third carrier; a fourth carrier and a fourth antenna mounted on the fourth carrier, wherein the third antenna and the fourth antenna are arranged relative to each other that the third antenna and the fourth antenna can communicate wirelessly with each other; a waveguide structure (which may be the transmission structure), wherein a first portion of the waveguide structure is mechanically coupled to the second antenna and a second portion of the waveguide structure is mechanically coupled to the third antenna to allow a transmission of electromagnetic signals between the second antenna and the third antenna via the waveguide structure.

In Example 2, the subject matter of Example 1 can optionally include that at least one of the first carrier or the fourth carrier is a rigid carrier.

In Example 3, the subject matter of Example 2 can optionally include that at least one of the first carrier or the fourth carrier is a printed circuit board.

In Example 4, the subject matter of any one of Examples 1 to 3 can optionally include that at least one of the second carrier or the third carrier is a flexible carrier.

In Example 5, the subject matter of Example 4 can optionally include that at least one of the second carrier or the third carrier is a flexible printed circuit board.

In Example 6, the subject matter of any one of Examples 1 to 5 can optionally include that the first carrier and the second carrier are arranged at a predefined first distance from each other.

In Example 7, the subject matter of Example 6 can optionally include that the first distance is smaller than or equal to about three times the wavelength of a wireless signal transmitted between the first antenna and the second antenna.

In Example 8, the subject matter of any one of Examples 1 to 7 can optionally include that the third carrier and the fourth carrier are arranged at a predefined second distance from each other.

In Example 9, the subject matter of Example 8 can optionally include that the second distance is smaller than or equal to about three times the wavelength of a wireless signal transmitted between the third antenna and the fourth antenna.

In Example 10, the subject matter of any one of Examples 1 to 9 can optionally include that the first antenna and the second antenna are galvanically separated from each other.

In Example 11, the subject matter of any one of Examples 1 to 10 can optionally include that the third antenna and the fourth antenna are galvanically separated from each other.

In Example 12, the subject matter of any one of Examples 1 to 11 can optionally include at least one of logic circuitry mounted on the first carrier or logic circuitry mounted on the fourth carrier.

In Example 13, the subject matter of any one of Examples 1 to 12 can optionally include that the first carrier and the first antenna are encapsulated in a first package.

In Example 14, the subject matter of any one of Examples 1 to 13 can optionally include that the fourth carrier and the fourth antenna are encapsulated in a second package.

In Example 15, the subject matter of any one of Examples 1 to 14 can further optionally include a system carrier; wherein the first carrier and the fourth carrier are mounted on the system carrier.

In Example 16, the subject matter of any one of Examples 1 to 15 can further optionally include at least one further carrier and a further antenna mounted on the further carrier, wherein the third antenna and the further antenna are arranged relative to each other that the third antenna and the further antenna can communicate wirelessly with each other.

In Example 17, the subject matter of Example 16 can optionally include that the at least one further carrier is a rigid carrier.

In Example 18, the subject matter of Example 17 can optionally include that the at least one further carrier is a printed circuit board.

In Example 19, the subject matter of any one of Examples 16 to 18 can optionally include that the at least one further carrier is positioned next to the fourth carrier on a common system carrier.

In Example 20, the subject matter of any one of Examples 16 to 19 can optionally include that the third antenna and the at least one further antenna are galvanically separated from each other.

In Example 21, the subject matter of any one of Examples 16 to 20 can optionally include at least one of logic circuitry mounted on the at least one further carrier.

In Example 22, the subject matter of any one of Examples 16 to 21 can optionally include that the further carrier and the further antenna are encapsulated in a further package.

In Example 23, the subject matter of any one of Examples 1 to 22 can optionally include that the waveguide structure is a structure selected from a group consisting of: stripline waveguide; dielectric waveguide; and coplanar waveguide.

Example 24 is a communication system, including: a first package including a first carrier and a first antenna; a second carrier and a second antenna galvanically separated from the first antenna, wherein the first antenna and the second antenna are configured to establish a first wireless communication connection; a third carrier and a third antenna; a second package including a fourth carrier and a fourth antenna; wherein the third antenna is galvanically separated from the fourth antenna, wherein the third antenna and the fourth antenna are configured to establish a second wireless communication connection; a waveguide structure, within which the signal propagate through, connects a second and third antenna. As an example, a first end portion of the waveguide structure is coupled to the second antenna and a second end portion of the waveguide structure is coupled to the third antenna to allow a waveguide signal transmission between the second antenna and the third antenna.

In Example 25, the subject matter of Example 24 can optionally include that at least one of the first carrier or the fourth carrier is a rigid carrier.

In Example 26, the subject matter of Example 25 can optionally include that at least one of the first carrier or the fourth carrier is a printed circuit board.

In Example 27, the subject matter of any one of Examples 24 to 26 can optionally include that at least one of the second carrier or the third carrier is a flexible carrier.

In Example 28, the subject matter of Example 27 can optionally include that at least one of the second carrier or the third carrier is a flexible printed circuit board.

In Example 29, the subject matter of any one of Examples 24 to 28 can optionally include that the first carrier and the second carrier are arranged at a predefined first distance from each other.

In Example 30, the subject matter of Example 29 can optionally include that the first distance is smaller than or equal to about three times the wavelength of a wireless signal transmitted between the first antenna and the second antenna.

In Example 31, the subject matter of any one of Examples 24 to 30 can optionally include that the third carrier and the fourth carrier are arranged at a predefined second distance from each other.

In Example 32, the subject matter of Example 31 can optionally include that the second distance is smaller than or equal to about three times the wavelength of a wireless signal transmitted between the third antenna and the fourth antenna.

In Example 33, the subject matter of any one of Examples 24 to 32 can optionally include at least one of logic circuitry mounted on the first carrier or logic circuitry mounted on the fourth carrier.

In Example 34, the subject matter of any one of Examples 24 to 33 can further optionally include a system carrier; wherein the first package and the second package are mounted on the system carrier.

In Example 35, the subject matter of any one of Examples 24 to 34 can optionally include at least one further package including a further carrier and a further antenna, wherein the third antenna and the further antenna are configured to establish a third wireless communication connection.

In Example 36, the subject matter of Example 35 can optionally include that the further carrier is a rigid carrier.

In Example 37, the subject matter of Example 36 can optionally include that the further carrier is a printed circuit board.

In Example 38, the subject matter of any one of Examples 35 to 37 can optionally include that the at least one further carrier is positioned next to the fourth carrier on a common system carrier.

In Example 39, the subject matter of any one of Examples 35 to 38 can optionally include that the third antenna and the at least one further antenna are galvanically separated from each other.

In Example 40, the subject matter of any one of Examples 35 to 39 can optionally include at least one of logic circuitry mounted on the further carrier.

In Example 41, the subject matter of any one of Examples 24 to 40 can optionally include that the waveguide structure is a structure selected from a group consisting of: stripline waveguide; dielectric waveguide; and coplanar waveguide.

Example 42 is an antenna, including: a ground layer patch; a second layer patch over the ground layer patch; a first layer patch over the second layer patch; a via array arranged at at least one edge of the first layer patch and the second layer patch and connecting the first layer patch with the second layer patch; and at least one feed probe configured to couple the ground layer patch with the first layer patch.

In Example 43, the subject matter of Example 42 can optionally further include a carrier, wherein the ground layer patch, the second layer patch and the first layer patch are formed on the same side of the carrier.

In Example 44, the subject matter of Example 43 can optionally include that the carrier is free of back side ground layer.

In Example 45, the subject matter of any one of Examples 42 to 44 can optionally further include that at least one of the first layer patch, the second layer patch, and the ground layer includes a slot.

In Example 46, the subject matter of Example 45 can optionally include that the feed probe is arranged adjacent to the slot.

In Example 47, the subject matter of any one of Examples 42 to 46 can optionally further include a microstrip line arranged in the layer of the second layer patch and coupled to the second layer patch.

In Example 48, the subject matter of Example 47 can optionally include that the microstrip line is galvanically isolated from the feed probe.

Example 49 is an antenna, including: a carrier, a ground layer patch; a third layer patch over the ground layer patch, wherein the third layer patch includes a waveguide structure arranged in the layer of the third layer patch and coupled to the third layer patch, and a first aperture; a second layer patch over the third layer patch, and a microstrip line arranged in the layer of the second layer patch and coupled to the second layer patch, and wherein the second layer patch includes a second aperture; a first layer patch over the second layer patch; a via array arranged at at least one edge of the first layer patch and second layer patch and connecting the first layer patch with the second layer patch, wherein the ground layer patch, the second layer patch and the first layer patch are formed on a first side of the carrier, and wherein the carrier includes a back side ground layer on a second side opposite to the first side; and a feed probe coupling the first layer patch with the waveguide structure in the layer of the third layer patch through the first aperture, the second aperture and the microstrip line.

In Example 50, the subject matter of any one of Examples 42 to 49 can optionally include that the first layer patch includes a rectangular shape.

In Example 51, the subject matter of any one of Examples 42 to 50 can optionally include that the second layer patch includes a rectangular shape.

In Example 52, the subject matter of any one of Examples 42 to 51 can optionally include that the first layer patch and the second layer patch have about an equal size.

In Example 53, the subject matter of any one of Examples 42 to 52 can optionally include that the first layer patch and the second layer patch have about an equal shape.

In Example 54, the subject matter of any one of Examples 42 to 53 can optionally include that the first layer patch and the second layer patch are arranged superimposed.

In Example 55, the subject matter of any one of Examples 42 to 54 can optionally include that the first layer patch and the second layer patch are arranged congruent.

In Example 56, the subject matter of any one of Examples 42 to 55 can optionally include that at least one of the first layer patch, the second layer patch, and the ground layer includes a slot.

In Example 57, the subject matter of any one of Examples 49 to 56 can optionally include that the slot includes a rectangular shape.

In Example 58, the subject matter of Example 57 can optionally include that the slot is enclosed by the second layer patch.

In Example 59, the subject matter of any one of Examples 47 to 58 can optionally include that the microstrip line is coupled to an edge of the second layer patch opposite of the edge having the via array.

In Example 60, the subject matter of any one of Examples 47 to 59 can optionally include that the second layer patch is free of slits adjacent to the microstrip line.

In Example 61, the subject matter of any one of Examples 42 to 60 can optionally further include one or more stubs coupled to the microstrip line.

In Example 62, the subject matter of Example 61 can optionally include that the stubs are configured as cross stub structure.

In Example 63, the subject matter of any one of Examples 61 to 62 can optionally include that the stubs are configured as a plurality of cross stub structure coupled along the microstrip line.

In Example 64, the subject matter of any one of Examples 42 to 63 can optionally include that the ground layer patch includes a rectangular shape.

In Example 65, the subject matter of any one of Examples 42 to 64 can optionally include that the ground layer patch has about an equal size to at least one of the first layer patch and the second layer patch.

In Example 66, the subject matter of any one of Examples 42 to 64 can optionally include that the ground layer patch has about an equal shape to at least one of the first layer patch and the second layer patch.

In Example 67, the subject matter of any one of Examples 42 to 68 can optionally include that the ground layer patch, the first layer patch, and the second layer patch are arranged superimposed.

In Example 68, the subject matter of any one of Examples 42 to 67 can optionally include that the ground layer patch, the first layer patch, and the second layer patch are arranged congruent.

In Example 69, the subject matter of any one of Examples 42 to 64 can optionally include that further including a dielectric between the ground layer patch and the second layer patch, and a dielectric between the second layer patch and the first layer patch.

In Example 70, the subject matter of any one of Examples 42 to 64 can optionally include that wherein at least one of the first layer patch and the second layer patch includes a width that is about λ/2, wherein the λ is the wavelength corresponding to the designated resonant frequency of the antenna.

In Example 71, the subject matter of any one of Examples 42 to 70 can optionally include that at least one of the first layer patch and the second layer patch includes a length that is about λ/4, wherein the λ is the wavelength corresponding to the designated resonant frequency of the antenna.

In Example 72, the subject matter of any one of Examples 42 to 71 can optionally include that the first layer patch and the second layer patch have about the same length and about the same width.

In Example 73, the subject matter of any one of Examples 42 to 72 can optionally include that the layer of the first layer patch further includes a feed network, a connector, and a matching network.

In Example 74, the subject matter of any one of Examples 42 to 73 can optionally include that the antenna is a folded patch antenna.

In Example 75, the subject matter of any one of Examples 42 to 74 can optionally include that the vias of the via array are electrically coupled in parallel.

Example 76 is a communication link structure for a chip module, including on a flexible substrate: a waveguide structure, a first antenna having a first feed, and a second antenna having a second feed, wherein the waveguide structure electrically conductively couples the first feed with the second feed.

In Example 77, the subject matter of Example 76 can optionally include that the communication link structure includes a thickness of less than 125 μm.

In Example 78, the subject matter of Example 76 or 77 can optionally include that the flexible substrate is a printed circuit board.

In Example 79, the subject matter of any one of Examples 76 to 78 can optionally include that at least one of the first antenna and the second antenna is configured according to any one of Examples 42 to 75.

In example 80, the subject matter of any one of the Examples 1 to 41 can optionally include that at least one of the antennas includes a ground layer patch; a second layer patch over the ground layer patch; a first layer patch over the second layer patch; a via array arranged at at least one edge of the first layer patch and second layer patch and connecting the first layer patch with the second layer patch; and at least one feed probe configured to couple the ground layer patch with the first layer patch.

In Example 81, the subject matter of Example 80 can optionally include a microstrip line arranged in the layer of the second layer patch and coupled to the second layer patch, wherein the microstrip line is galvanically isolated or disconnected from the feed probe.

In example 82, the subject matter of any one of the Examples 80 to 81 can optionally include a microstrip line coupled to an edge of the second layer patch opposite of the edge having the via array.

In example 83, the subject matter of any one of the Examples 80 to 82 can optionally include one or more stubs coupled to the microstrip line

In example 84, the subject matter of any one of the Examples 1 to 41, and 80 to 83 can optionally include that at least one of the antennas includes a carrier, a ground layer patch; a third layer patch over the ground layer patch, wherein the third layer patch includes a waveguide structure arranged in the layer of the third layer patch and coupled to the third layer patch and a first aperture; a second layer patch over the third layer patch, and a microstrip line arranged in the layer of the second layer patch and coupled to the second layer patch, and wherein the second layer patch includes a second aperture; a first layer patch over the second layer patch; a via array arranged at at least one edge of the first layer patch and second layer patch and connecting the first layer patch with the second layer patch; wherein the ground layer patch, the second layer patch and the first layer patch are formed on a first side of the carrier, and wherein the carrier includes a back side ground layer on a second side opposite to the first side; and a feed probe coupling the first layer patch with the waveguide structure in the layer of the third layer patch through the first aperture, the second aperture and the microstrip line.

In example 85, the subject matter of Example 84 can optionally include the second layer patch is free of slits adjacent to the microstrip line.

In example 86, the subject matter of any one of the Examples 84 to 85 can optionally include The system of claim 10 or 11, further including one or more stubs coupled to the microstrip line

In example 87, the subject matter of any one of the Examples 84 to 86 can optionally include the the antenna is a folded patch antenna.

In example 88, the subject matter of any one of the Examples 84 to 87 can optionally include the vias of the via array are electrically coupled in parallel.

In example 89, the subject matter of any one of the Examples 1 to 41, and 80 to 88 can optionally include that the transmission structure includes on a flexible substrate: a waveguide structure, the second antenna having a first feed, and the third antenna having a second feed, wherein the waveguide structure electrically couples the first feed with the second feed.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A communication system, comprising:
a first carrier and a first antenna mounted on the first carrier;
a second carrier and a second antenna mounted on the second carrier, wherein the first antenna and the second antenna are arranged relative to each other that the first antenna and the second antenna can establish wireless link;
a third carrier and a third antenna mounted on the third carrier;
a fourth carrier and a fourth antenna mounted on the fourth carrier, wherein the third antenna and the fourth antenna are arranged relative to each other that the third antenna and the fourth antenna can establish wireless link;
a transmission structure, within which the signal propagate through, connects the second antenna and the third antenna.

2. The system of claim 1, wherein the first carrier and the second carrier are arranged at a predefined first distance from each other.

3. The system of claim 2, wherein the first distance is smaller than or equal to about three times the wavelength of a wireless signal transmitted between the first antenna and the second antenna.

4. The system of claim 1, wherein the first antenna and the second antenna are galvanically separated from each other.

5. The system of claim 1, wherein the first carrier and the first antenna are encapsulated in a first package, and wherein the fourth carrier and the fourth antenna are encapsulated in a second package.

6. The system of claim 1, wherein at least one of the antennas comprises:
a ground layer patch;
a second layer patch over the ground layer patch;
a first layer patch over the second layer patch;
a via array arranged at at least one edge of the first layer patch and second layer patch and connecting the first layer patch with the second layer patch; and
at least one feed probe configured to couple the ground layer patch with the first layer patch.

7. The system of claim 6, further comprising a microstrip line arranged in the layer of the second layer patch and coupled to the second layer patch, wherein the microstrip line is galvanically isolated or disconnected from the feed probe.

8. The system of claim 6, further comprising a microstrip line coupled to an edge of the second layer patch opposite of the edge having the via array.

9. The system of claim 6, further comprising one or more stubs coupled to the microstrip line.

10. The system of claim 1, wherein at least one of the antennas comprises:
a carrier,
a ground layer patch;
a third layer patch over the ground layer patch, wherein the third layer patch comprises a waveguide structure arranged in the layer of the third layer patch and coupled to the third layer patch and a first aperture;
a second layer patch over the third layer patch, and a microstrip line arranged in the layer of the second layer patch and coupled to the second layer patch, and wherein the second layer patch comprises a second aperture;
a first layer patch over the second layer patch;
a via array arranged at at least one edge of the first layer patch and second layer patch and connecting the first layer patch with the second layer patch;
wherein the ground layer patch, the second layer patch and the first layer patch are formed on a first side of the carrier, and wherein the carrier comprises a back side ground layer on a second side opposite to the first side; and
a feed probe coupling the first layer patch with the waveguide structure in the layer of the third layer patch through the first aperture, the second aperture and the microstrip line.

11. The system of claim 10, wherein the second layer patch is free of slits adjacent to the microstrip line.

12. The system of claim 10, further comprising one or more stubs coupled to the microstrip line.

13. The system of claim 10, wherein the antenna is a folded patch antenna.

14. The system of claim 10, wherein the vias of the via array are electrically coupled in parallel.

15. The system of claim 1, wherein the transmission structure comprises on a flexible substrate:
a waveguide structure,
the second antenna having a first feed, and
the third antenna having a second feed, wherein the waveguide structure electrically couples the first feed with the second feed.

16. An antenna, comprising:
a ground layer patch;
a second layer patch over the ground layer patch;
a first layer patch over the second layer patch;
a via array arranged at at least one edge of the first layer patch and second layer patch and connecting the first layer patch with the second layer patch; and
at least one feed probe configured to couple the ground layer patch with the first layer patch.

17. The antenna of claim 16, further comprising an antenna carrier, wherein the ground layer patch, the second layer patch and the first layer patch are formed on the same side of the antenna carrier, and wherein the antenna carrier is free of back side ground layer.

18. A communication link structure for a chip module, comprising on a flexible substrate:
a waveguide structure,
a first antenna having a first feed, and
a second antenna having a second feed, wherein the waveguide structure electrically couples the first feed with the second feed.

19. The communication link structure of claim 18, wherein at least one of the first antenna and the second antenna comprises at least:
a second layer patch over a ground layer patch;
a first layer patch over the second layer patch;
a via array arranged at at least one edge of the first layer patch and second layer patch and connecting the first layer patch with the second layer patch.

20. The communication link structure of claim 18,
wherein the communication link structure comprises a thickness of less than 125 μm.
